(19) United States
(12) Patent Application Publication
(10) Pub. No.: US 2019/0035316 A1
(43) Pub. Date: Jan. 31, 2019

(54) DEFECT DETECTION METHOD AND DEFECT DETECTION DEVICE

(71) Applicants: BOE TECHNOLOGY GROUP CO., LTD., Beijing (CN); CHENGDU BOE OPTOELECTRONICS TECHNOLOGY CO., LTD., Chengdu (CN)

(72) Inventor: Ze LIU, Beijing (CN)

(73) Assignees: BOE TECHNOLOGY GROUP CO., LTD., Beijing (CN); CHENGDU BOE OPTOELECTRONICS TECHNOLOGY CO., LTD., Chengdu (CN)

(21) Appl. No.: 15/957,434

(22) Filed: Apr. 19, 2018

(30) Foreign Application Priority Data
Jul. 31, 2017 (CN) 201710645587.5

(51) Int. Cl. G09G 3/00; G06T 7/00

(52) U.S. Cl. CPC G09G 3/006; G06T 2207/30121; G06T 7/0004

(57) ABSTRACT

The present disclosure provides a defect detection method and a defect detection device. The defect detection method includes steps of: collecting a test pattern displayed on a to-be-detected display panel arranged in a first orientation to acquire first quantized data about a ROI in the test pattern; moving the to-be-displayed panel to a second orientation different from the first orientation; collecting a test pattern displayed on the to-be-detected display panel in the second orientation to acquire second quantized data about the ROI in the test pattern; and determining an actual defect in the ROI in accordance with the first quantized data and the second quantized data about the ROI.

### CROSS-REFERENCE TO RELATED APPLICATION

This application claims priority to Chinese Patent Application No. 201710645587.5 filed on Jul. 31, 2017, which is incorporated herein by reference in its entirety.

### TECHNICAL FIELD

The present disclosure relates to the field of automatic optical defect detection, in particular to a defect detection method and a defect detection device.

### BACKGROUND

Currently, an automatic optic inspection (AOI) algorithm is adopted in a factory to detect a defect of a liquid crystal display (LCD) panel. Usually, this algorithm includes two critical steps, i.e., region of interest (ROI) segmentation and defect quantization. During the defect quantization, brightness of a pattern generated on a to-be-detected panel is quantized in accordance with a certain criterion to acquire the quantized data, and then the defect is determined in accordance with a comparison result acquired by comparing the quantized data with brightness data of a pattern generated on a standard panel as well as a relevant defect standard.

However, due to the defect of the LCD panel, e.g., Mura, a size, a position and shape of the ROI are not fixed, and they are easily affected by an environment, especially light. In the case that a single defect quantization algorithm is adopted, the quantized data may not change. It is impossible to radically reduce an error rate due to the defect caused by an external environment merely by changing a detection threshold. Of course, multiple parameters or a high-precision camera may be used to reduce the error rate. However, this method has a long debugging time period, and it is necessary to debug a device again in the case that a type thereof changes, so the cost is relatively high.

### SUMMARY

In one aspect, the present disclosure provides in some embodiments a defect detection method, including steps of: collecting a test pattern displayed on a to-be-detected display panel arranged in a first orientation to acquire first quantized data about a ROI in the test pattern; moving the to-be-displayed panel to a second orientation different from the first orientation; collecting a test pattern displayed on the to-be-detected display panel in the second orientation to acquire second quantized data about the ROI in the test pattern, the ROI being contained in the test pattern displayed on the to-be-detected panel in the first orientation and the test pattern displayed on the to-be-detected panel in the second orientation; and determining an actual defect in the ROI in accordance with the first quantized data and the second quantized data about the ROI.

In a possible embodiment of the present disclosure, the step of determining the actual defect in the ROI in accordance with the first quantized data and the second quantized data about the ROI includes: acquiring an absolute value of a difference between quantized data in each of the first quantized data and the second quantized data corresponding to an identical position in the ROI and a reference value; comparing an average value of the absolute values with a threshold value; in the case that the average value is greater than the threshold value, determining that the to-be-detected panel has the actual defect at the position in the ROI; and in the case that the average value is smaller than or equal to the threshold value, determining that the to-be-detected panel does not have the actual defect at the position in the ROI.

In a possible embodiment of the present disclosure, the step of collecting the test pattern displayed on the to-be-detected panel in the first orientation to acquire the first quantized data about the ROI in the test pattern includes collecting a plurality of test patterns displayed on the to-be-detected panel in the first orientation to acquire an average value of quantized data about the ROI in the test patterns as the first quantized data.

In a possible embodiment of the present disclosure, the step of collecting the test pattern displayed on the to-be-detected panel in the second orientation to acquire the second quantized data about the ROI in the test pattern includes collecting a plurality of test patterns displayed on the to-be-detected panel in the second orientation to acquire an average value of quantized data about the ROI in the test patterns as the second quantized data.

In a possible embodiment of the present disclosure, the step of moving the to-be-detected panel to the second orientation includes rotating the to-be-detected panel by 180° to the second orientation.

In a possible embodiment of the present disclosure, the ROI includes the entire test pattern, or the test pattern includes a plurality of ROIs.

In a possible embodiment of the present disclosure, the reference value is quantized data about the ROI in a test pattern displayed on a reference panel without any defect.

In a possible embodiment of the present disclosure, the quantized data is a brightness value.

In a possible embodiment of the present disclosure, the to-be-detected panel is an LCD panel or an organic light-emitting diode (OLED) panel.

In another aspect, the present disclosure provides in some embodiments a defect detection device, including: a collection unit configured to collect a test pattern displayed on a to-be-detected panel in a first orientation and a test pattern displayed on the to-be-detected panel in a second orientation different from the first orientation; an acquisition circuit configured to acquire first quantized data about a ROI in the test pattern displayed on the to-be-detected panel in the first orientation and second quantized data about the ROI in the test pattern displayed on the to-be-detected panel in the second orientation; a movement unit configured to move the to-be-detected panel from the first orientation to the second orientation; and a determination circuit configured to determine an actual defect in the ROI in accordance with the first quantized data and the second quantized data about the ROI.

In a possible embodiment of the present disclosure, the determination circuit is further configured to: acquire an absolute value of a difference between quantized data in each of the first quantized data and the second quantized data corresponding to an identical position in the ROI and a reference value; compare an average value of the absolute values with a threshold value; in the case that the average value is greater than the threshold value, determine that the to-be-detected panel has the actual defect at the position in the ROI; and in the case that the average value is smaller than or equal to the threshold value, determine that the to-be-detected panel does not have the actual defect at the position in the ROI.

In a possible embodiment of the present disclosure, the movement unit includes a working table configured to carry thereon the to-be-detected panel and an electric motor configured to move the working table.

In a possible embodiment of the present disclosure, the movement unit further includes a securing member configured to secure the to-be-detected panel.

In a possible embodiment of the present disclosure, the movement unit is further configured to rotate the to-be-detected panel by 180° to move the to-be-detected panel from the first orientation to the second orientation.

In a possible embodiment of the present disclosure, the collection unit is a charge coupled device (CCD).

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flow chart of a defect detection method according to one embodiment of the present disclosure;

FIG. 2 is a schematic view showing the arrangement of a to-be-detected panel according to one embodiment of the present disclosure;

FIG. 3 is another schematic view showing the arrangement of the to-be-detected panel according to one embodiment of the present disclosure;

FIG. 4 is yet another schematic view showing the arrangement of the to-be-detected panel according to one embodiment of the present disclosure;

FIG. 5 is a curve diagram of first quantized data about a test pattern displayed on the to-be-detected panel in a first orientation according to one embodiment of the present disclosure; and

FIG. 6 is a curve diagram of second quantized data about a test pattern displayed on the to-be-detected panel in a second orientation according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

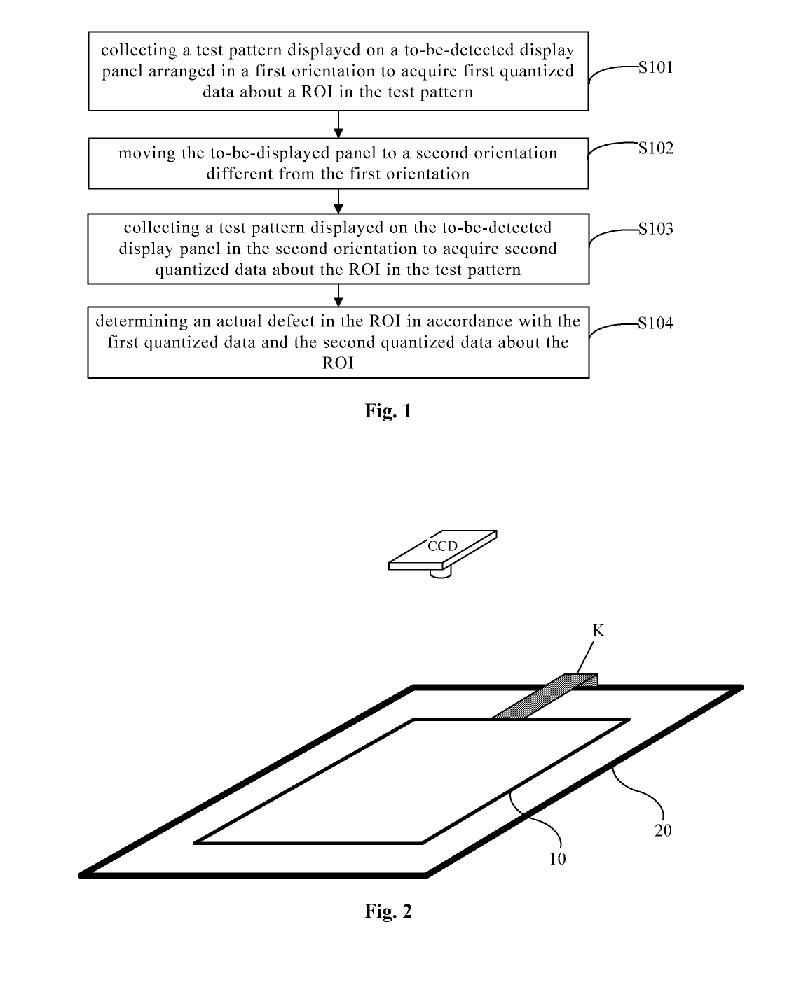

The present disclosure provides in some embodiments a defect detection method, e.g., an AOI defect detection method. As shown in FIG. 1, thee defect detection method includes the following steps.

Step S101: collecting a test pattern displayed on a to-be-detected display panel arranged in a first orientation to acquire first quantized data about a ROI in the test pattern.

To be specific, in the case that the to-be-detected panel 10 is arranged in the first orientation (as shown in FIG. 2), the test pattern displayed on the to-be-detected panel may be collected, and then the first quantized data about the ROI in the test pattern may be acquired. The entire test pattern or a part of the test pattern may serve as the ROI, and there may exist one or more ROIs.

It should be appreciated that, usually the quantized data (the first quantized data or second quantized data mentioned hereinafter) may include a brightness value of the ROI, or any other parameter. The test pattern may be a pattern where such a defect as Mura (including points or lines) is to be detected possibly.

In addition, the to-be-detected panel may be a LCD panel or an OLED panel, which will not be particularly defined herein.

Step S102: moving the to-be-displayed panel to a second orientation different from the first orientation.

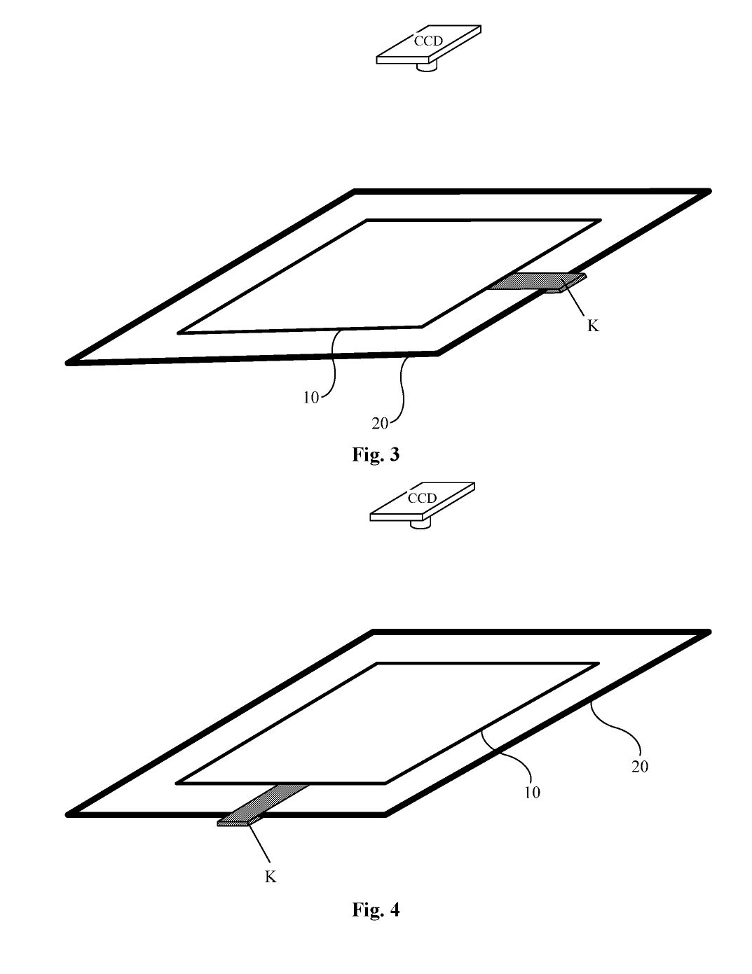

To be specific, the to-be-detected panel may be moved from the first orientation (as shown in FIG. 2) to the second orientation (as shown in FIG. 3) different from the first orientation. The second orientation in FIG. 3 is acquired by merely rotating the to-be-detected panel in the first orientation in FIG. 2 by 90°. Of course, the to-be-detected panel may also be rotated by 120° or 150°, or translated, which will not be particularly defined herein. The following description is given by taking a rotation mode as an example.

During the defect detection, usually parameters of a light beam transmitted toward the to-be-detected panel (including a direction and an intensity of the light beam as well as an angle of the light beam relative to an image collection unit) are fixed. In order to ensure a maximum environmental difference in the case that an identical portion of the to-be-detected panel in the first orientation and the second orientation is irradiated by the light beam, in a possible embodiment of the present disclosure, Step S102 may include rotating the to-be-detected panel by 180° to the second orientation (as shown in FIG. 4). In this way, it is able to further improve the detection accuracy of the actual defect.

In addition, the to-be-detected panel 10 in FIG. 2 may be rotated by 90° to the orientation in FIG. 3 or by 180° to the orientation in FIG. 4 with reference to a position of a securing unit K for securing the to-be-detected panel 10 in FIGS. 2, 3 and 4. Usually, the securing unit K is fixed on a working table 20 carrying thereon the to-be-detected panel 10.

Step S103: collecting a test pattern displayed on the to-be-detected display panel in the second orientation to acquire second quantized data about the ROI in the test pattern.

To be specific, in the case that the to-be-detected panel 10 is arranged in the second orientation (as shown in FIG. 3), the test pattern displayed on the to-be-detected panel 10 maybe collected, and then the second quantized data about the ROI in the test pattern may be acquired.

Step S104: determining an actual defect in the ROI in accordance with the first quantized data and the second quantized data about the ROI.

According to the defect detection method in the embodiments of the present disclosure, the to-be-detected panel is moved from the first orientation to the second orientation, the first quantized data and the second quantized data about the same ROI of the to-be-detected panel in the first orientation and the second orientation are acquired, and then the actual defect of the to-be-detected panel is determined in accordance with the first quantized data and the second quantized data. As compared with the related art where the actual defect of the to-be-detected panel is determined merely in accordance with the quantized data acquired in one orientation, in the embodiments of the present disclosure, it is able to reduce the error rate during the defect detection and improve the detection accuracy.

In a possible embodiment of the present disclosure, Step S104 may include: acquiring an absolute value of a difference between quantized data in each of the first quantized data and the second quantized data corresponding to an identical position in the ROI and a reference value; comparing an average value of the absolute values with a threshold value; in the case that the average value is greater than the threshold value, determining that the to-be-detected panel has the actual defect at the position in the ROI; and in the case that the average value is smaller than or equal to the threshold value, determining that the to-be-detected panel does not have the actual defect at the position in the ROI.

It should be appreciated that, each of the first quantized data and the second quantized data about all regions of the entire test pattern may be acquired. Of course, the quantized data about all regions of the entire test pattern may be acquired in the case that the to-be-detected panel is in the first orientation, a region where more defects (e.g., Mura) are located may be determined as the ROI, and then the first quantized data about the ROI may be acquired. Then, the to-be-detected panel may be rotated to acquire the second quantized data about the ROI.

To be specific, the reference value may be 100, and the threshold value may be 5. Of course, the threshold value may be set in accordance with the practical need. For example, for the highly demanding panel, a smaller threshold value may be set, e.g., 3 or 4. The reference value may be set in accordance with an entire testing environment (e.g., an illumination condition). For example, a quantized parameter of the standard panel without any defect may be taken as the reference value. In addition, before and after the ROI in the test pattern has been rotated, the quantized data corresponding to the identical position in the ROI may be acquired in accordance with an actual rotation angle through image differential treatment. Further, before and after the ROI in the test pattern has been rotated, the identical position in the ROI may be calculated simply through geometric operation, which will be deduced appropriately and thus will not be particularly defined herein.

In the case that the reference value is 100 and the threshold value is 5, two differences X1 and X2 between the quantized data in the first quantized data and the second quantized data corresponding to the identical position in the ROI and the reference value (i.e., 100) may be acquired, and the average value of the absolute values of the two differences X1 and X2, i.e.,

$$\frac{\vert X 1 \vert + \vert X 2 \vert}{2} ,$$

may be compared with the threshold value (i.e., 5). In the case that

$$\frac{\vert X 1 \vert + \vert X 2 \vert}{2} > 5 ,$$

it means that the to-be-detected panel has the actual defect at this position, and in the case that

$$\frac{\vert X 1 \vert + \vert X 2 \vert}{2} \leq 5 ,$$

it means that the to-be-detected panel does not have the actual defect at this position.

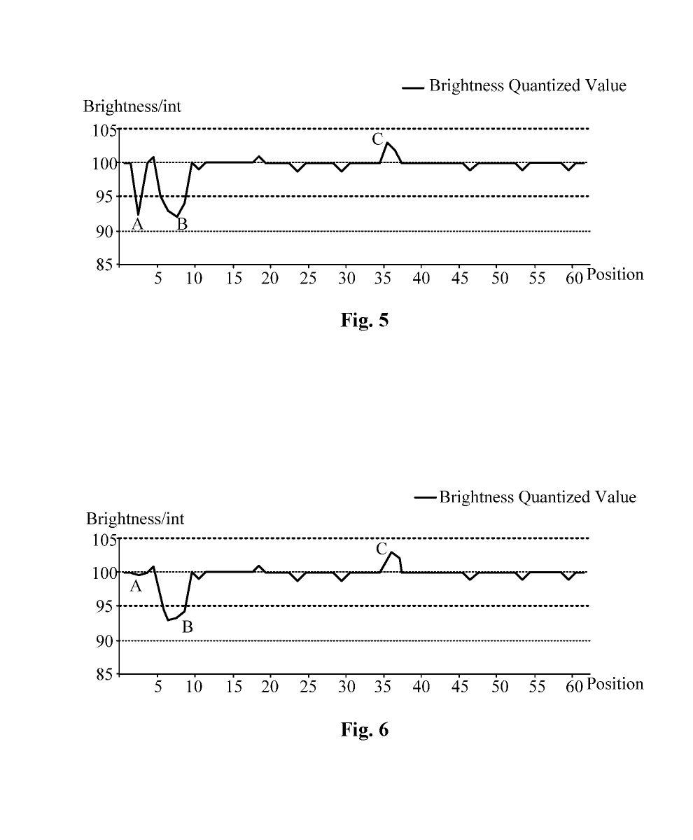

FIG. 5 is a curve diagram of the first quantized data (brightness) about the ROI in the test pattern acquired through Step S101, and FIG. 6 is a curve diagram of the second quantized data (brightness) about the ROI in the test pattern acquired through Step S102 (e.g., rotating the to-be-detected panel by) 180° and Step S103). As shown in FIG. 5, in the case that the to-be-detected panel is in the first orientation, the quantized data at position A and position B is 94 and 93 respectively. In the related art, it may be directly determined that the to-be-detected panel has the defects at positions A and B.

However, in the embodiments of the present disclosure, through an additional step (i.e., rotating the to-be-detected panel to the second orientation), as shown in FIG. 6, the quantized data at positions A and B is 99.5 and 94 respectively. For position A, the quantized data is 94 and 99.5, and the differences between the quantized data and the reference value (i.e., 100) are −6 and −0.5. The average value of the absolute values of the two differences is 3.25, which is smaller than the threshold value (i.e., 5), so the to-be-detected panel does not have the actual defect at position A. For position B, the quantized data is 93 and 94, and the differences between the quantized data and the reference value (i.e., 100) are −7 and −6. The average value of the absolute values of the two differences is 6.5, which is greater than 5, so the to-be-detected panel has the actual defect at position B.

It can therefore be seen that, in the embodiments of the present disclosure, there is a relatively large difference between the pieces of quantized data before and after the rotation of the to-be-detected panel at position A, and the average value of the absolute values of the two differences between the quantized data and the reference value is smaller than the predetermined threshold value, so the to-be-detected panel does not have the actual defect at position A, i.e., the defect may be caused by a system error (e.g., the angle of the light beam relative to the to-be-detected panel). For position B, the average value of the absolute values of the two differences between the quantized data and the reference value before and after the rotation of the to-be-detected panel is greater than the predetermined threshold, so the to-be-detected panel has the actual defect at positon B. For each of the other positions, the average value of the absolute values of the two differences between the quantized data and the reference value before and after the rotation of the to-be-detected panel is smaller than the predetermined threshold value, so the to-be-detected panel does not have the actual defect at these positions.

In a word, in the related art, the to-be-detected panel may have the actual defects at positions A and B. However, in the embodiments of the present disclosure, the defects caused by the system error, e.g., the defect at position A, may be omitted, so it is able to improve the detection accuracy of the defects on the to-be-detected panel, and reduce the error rate. The display panel which is determined as OK in the related art may be determined as not good (NG) in the case that the defect detection method in the embodiments of the present disclosure is adopted, while the display panel which is determined as NG in the related art may be determined as OK.

In addition, it should be appreciated that, as compared with the related art, through the defect detection method in the embodiments of the present disclosure, it is able to improve the detection accuracy while omitting the defect caused by the system error. For example, for position B, the detection may be performed before and after the rotation of the to-be-detected panel, and the to-be-detected panel may be determined as having the actual defect merely in the case that the average value is greater than the threshold value. Further, in the case that there is an obvious difference between the quantized data and the reference value at the identical position before and after the rotation of the to-be-detected panel but the average value is smaller than the threshold value, it is able to determine a level of the to-be-detected panel in accordance with the quantized data. For example, for position C, the quantized data (103 and 102.5) is acquired before and after the rotation of the to-be-detected panel, and the average value of the absolute values of the differences between the quantized data and the reference value (i.e., 100) is smaller than 5. At this time, the average value may be taken as a basis for determining the level of the to-be-detected panel.

For example, a defect detection rate of the to-be-displayed panel is 70% in the case that a conventional method is adopted (i.e., 30% defects are not actual defects), but in the case that the method in the embodiments of the present disclosure is adopted, the actual defects contained in the 30% defects may be detected, so as to improve the defect detection rate. For another example, an error rate is 10% in the case that the conventional method is adopted (i.e., 10% defects are erroneously detected as the actual defects), but in the case that the method in the embodiments of the present disclosure is adopted, it is able to reduce the error rate.

In order to ensure the detection accuracy, in a possible embodiment of the present disclosure, Step S101 may include collecting a plurality of test patterns displayed on the to-be-detected panel in the first orientation to acquire an average value of quantized data about the ROI in the test patterns as the first quantized data.

Identically, Step S103 may include collecting a plurality of test patterns displayed on the to-be-detected panel in the second orientation to acquire an average value of quantized data about the ROI in the test patterns as the second quantized data.

As mentioned above, the plurality of test patterns displayed on the to-be-detected panel in the first orientation and/or the plurality of test patterns displayed on the to-be-detected panel in the second orientation may be collected to acquire the average values of quantized data about the ROI in the test patterns as the first and/or second quantized data. As a result, it is able to improve the accuracy of the first quantized data and the second quantized data, thereby to further improve the detection accuracy and reduce the error rate.

The present disclosure further provides in some embodiments a defect detection device which includes a collection unit, an acquisition circuit, a movement unit and a determination circuit.

To be specific, the collection unit is configured to collect a test pattern displayed on a to-be-detected panel in a first orientation and a test pattern displayed on the to-be-detected panel in a second orientation different from the first orientation. The acquisition circuit is configured to acquire first quantized data about a ROI in the test pattern displayed on the to-be-detected panel in the first orientation and second quantized data about the ROI in the test pattern displayed on the to-be-detected panel in the second orientation. The movement unit is configured to move the to-be-detected panel from the first orientation to the second orientation. The determination circuit is configured to determine an actual defect in the ROI in accordance with the first quantized data and the second quantized data about the ROI.

In a possible embodiment of the present disclosure, the determination circuit is further configured to: acquire an absolute value of a difference between quantized data in each of the first quantized data and the second quantized data corresponding to an identical position in the ROI and a reference value; compare an average value of the absolute values with a threshold value; in the case that the average value is greater than the threshold value, determine that the to-be-detected panel has the actual defect at the position in the ROI; and in the case that the average value is smaller than or equal to the threshold value, determine that the to-be-detected panel does not have the actual defect at the position in the ROI.

In a possible embodiment of the present disclosure, the collection unit is a CCD capable of converting optical information into an electric signal. It should be appreciated that, in the case of collecting the test pattern through the CCD, it is necessary to ensure a focus of the CCD to be located at a center of the to-be-detected panel 10 as possible. Usually, the focus of the CCD may be adjusted through a mechanical arm.

In a possible embodiment of the present disclosure, the acquisition circuit or the determination circuit may be implemented through appropriate electronic elements, e.g., capacitors, resistors and transistors, or through a processor in combination with a corresponding circuit.

As shown in FIGS. 2 to 4, the movement unit includes a working table 20 configured to carry thereon the to-be-detected panel 10 and an electric motor (e.g., a rotary motor) configured to move the working table 20. The movement unit may further include a securing member K configured to secure the to-be-detected panel 10.

In a possible embodiment of the present disclosure, the movement unit is further configured to rotate the to-be-detected panel by 180° to move the to-be-detected panel from the first orientation to the second orientation. To be specific, the rotor motor may drive the working table 20 to rotate by 180° to drive the to-be-detected panel 10 to rotate by 180°, i.e., to rotate from the first orientation to the second orientation. Of course, after the detection, the to-be-detected panel 10 may be delivered by the movement unit away from the working table 20.

It should be appreciated that, all of, or parts of, the steps may be implemented through hardware associated with programs or instructions. The programs may be stored in a computer-readable storage medium, and executed to perform the above-mentioned steps. The storage medium includes any media capable of storing therein program codes, such as Read Only Memory (ROM), Random Access Memory (RAM), magnetic disc or optical disc.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A defect detection method, comprising steps of:
collecting a test pattern displayed on a to-be-detected display panel arranged in a first orientation to acquire first quantized data about a Region of Interest (ROI) in the test pattern;
moving the to-be-displayed panel to a second orientation different from the first orientation;
collecting a test pattern displayed on the to-be-detected display panel in the second orientation to acquire second quantized data about the ROI in the test pattern, the ROI being contained in the test pattern displayed on the to-be-detected panel in the first orientation and the test pattern displayed on the to-be-detected panel in the second orientation; and
determining an actual defect in the ROI in accordance with the first quantized data and the second quantized data about the ROI.

2. The defect detection method according to claim 1, wherein the step of determining the actual defect in the ROI in accordance with the first quantized data and the second quantized data about the ROI comprises:
acquiring an absolute value of a difference between quantized data in each of the first quantized data and the second quantized data corresponding to an identical position in the ROI and a reference value;
comparing an average value of the absolute values with a threshold value;
in the case that the average value is greater than the threshold value, determining that the to-be-detected panel has the actual defect at the position in the ROI; and
in the case that the average value is smaller than or equal to the threshold value, determining that the to-be-detected panel does not have the actual defect at the position in the ROI.

3. The defect detection method according to claim 1, wherein the step of collecting the test pattern displayed on the to-be-detected panel in the first orientation to acquire the first quantized data about the ROI in the test pattern comprises collecting a plurality of test patterns displayed on the to-be-detected panel in the first orientation to acquire an average value of quantized data about the ROI in the test patterns as the first quantized data.

4. The defect detection method according to claim 1, wherein the step of collecting the test pattern displayed on the to-be-detected panel in the second orientation to acquire the second quantized data about the ROI in the test pattern comprises collecting a plurality of test patterns displayed on the to-be-detected panel in the second orientation to acquire an average value of quantized data about the ROI in the test patterns as the second quantized data.

5. The defect detection method according to claim 1, wherein the step of moving the to-be-detected panel to the second orientation comprises rotating the to-be-detected panel by 180° to the second orientation.

6. The defect detection method according to claim 1, wherein the ROI comprises the entire test pattern, or the test pattern comprises a plurality of ROIs.

7. The defect detection method according to claim 2, wherein the reference value is quantized data about the ROI in a test pattern displayed on a reference panel without any defect.

8. The defect detection method according to claim 1, wherein the quantized data is a brightness value.

9. The defect detection method according to claim 1, wherein the to-be-detected panel is a liquid crystal display (LCD) panel or an organic light-emitting diode (OLED) panel.

10. A defect detection device, comprising:
a collection unit configured to collect a test pattern displayed on a to-be-detected panel in a first orientation and a test pattern displayed on the to-be-detected panel in a second orientation different from the first orientation;
an acquisition circuit configured to acquire first quantized data about a Region of Interest (ROI) in the test pattern displayed on the to-be-detected panel in the first orientation and second quantized data about the ROI in the test pattern displayed on the to-be-detected panel in the second orientation;
a movement unit configured to move the to-be-detected panel from the first orientation to the second orientation; and
a determination circuit configured to determine an actual defect in the ROI in accordance with the first quantized data and the second quantized data about the ROI.

11. The defect detection device according to claim 10, wherein the determination circuit is further configured to:
acquire an absolute value of a difference between quantized data in each of the first quantized data and the second quantized data corresponding to an identical position in the ROI and a reference value;
compare an average value of the absolute values with a threshold value;
in the case that the average value is greater than the threshold value, determine that the to-be-detected panel has the actual defect at the position in the ROI; and
in the case that the average value is smaller than or equal to the threshold value, determine that the to-be-detected panel does not have the actual defect at the position in the ROI.

12. The defect detection device according to claim 10, wherein the movement unit comprises a working table configured to carry thereon the to-be-detected panel and an electric motor configured to move the working table.

13. The defect detection device according to claim 10, wherein the movement unit further comprises a securing member configured to secure the to-be-detected panel.

14. The defect detection device according to claim 10, wherein the movement unit is further configured to rotate the to-be-detected panel by 180° to move the to-be-detected panel from the first orientation to the second orientation.

15. The defect detection device according to claim 10, wherein the collection unit is a charge coupled device (CCD).

16. The defect detection device according to claim 10, wherein the ROI comprises the entire test pattern, or the test pattern comprises a plurality of ROIs.

17. The defect detection device according to claim 11, wherein the reference value is quantized data about the ROI in a test pattern displayed on a reference panel without any defect.

18. The defect detection device according to claim 10, wherein the quantized data is a brightness value.
